(19) United States
(12) Patent Application Publication
(10) Pub. No.: US 2013/0277568 A1
(43) Pub. Date: Oct. 24, 2013

(54) Method for research of internal structure and / or contents of an object, obtaining an image of the object, and / or the internal structure, and / or the contents, and a system for executing the method

(71) Applicants: Andrei Yoryevich Sherbakov, Moscow (RU); Oleg Olegovich Tikhonenko, Moscow (RU)

(72) Inventors: Andrei Yoryevich Sherbakov, Moscow (RU); Oleg Olegovich Tikhonenko, Moscow (RU)

(21) Appl. No.: 13/453,317

(22) Filed: Apr. 23, 2012

(51) Int. Cl. G01N 23/20

(52) U.S. Cl. 250/393

(57) ABSTRACT

There are proposed methods for research of internal structure and/or contents of an object, obtaining an image therefor, and/or the internal structure and/or contents, and devices for executing thereof. They allow for analyzing object properties and qualities and for remotely controlling the objects. The methods and devices are distinct due to avoiding the necessity of placing a radiation source on one side of the object, and placing a radiation receptor on the other side, which enables imaging objects having significant dimensions, and objects jointed to each other. The proposed methods allow for imaging an object that cannot be imaged by traditional imaging methods, or objects that can be damaged or destroyed by radiation. The methods allow for reduction of radiation doses for the researched object, and surrounding objects; for raising the quality of information on the object's internal structure disregarding whether the radiation source moves, or the object moves.

### FIELD OF THE INVENTION

The invention relates to physics and material engineering, particularly to methods for research of internal structure and/or contents of an object, obtaining an image of the object, and/or the internal structure, and/or the contents, and devices for executing thereof.

The present invention can find useful applications in systems for research different objects, analyzing properties and qualities of the objects, and for remote control of the objects.

### BACKGROUND OF THE INVENTION

Nowadays, X-ray imaging is often employed for research of an object's internal structure without opening or dissembling thereof.

This however has a number of essential drawbacks. First, it's necessary to position an X-ray source on one side of the object, whereas an X-ray receiver is positioned at the other side of the object, which makes it impossible obtaining images of large size objects, as well as objects being parts of other objects (e.g. wheels and bumpers of transportation vehicles, etc.).

Further, some objects cannot be researched by X-ray imaging in principal (e.g. those located inside building walls, screened by steel sheets), or those that can be damaged by X-ray imaging (e.g. photo materials).

Besides, an important problem is a reduction of radiation exposure dose of the object, as well as of surrounding objects and personnel.

The present invention is intended for solving—the problem of creation of methods for research of internal structure and/or contents of an object, obtaining images of the object and/or its internal structure, and objects being parts of other objects; and—the problem of creation of methods for research of objects not accessible for through imaging and an essentially reduction of radiation exposure dose of objects.

The closest prior art document is Euro-Asian Patent No. 011316 titled “Method and device for obtaining information on internal structure of an object, and method for creation of imaging objects” herein further called a ‘prototype’. According to those methods, an object is irradiated by a movable narrow beam of penetrating radiation, containing an approximately equal number of quantas, and a reflected portion of the beam is registered from each irradiated section of a researched object, which portion is registered as a number of quantas, thereby obtaining a digital image of the object's internal structure.

However, such method possesses certain shortcomings, and does not adequately solve the aforementioned problems, e.g. sometimes operates with excessively great number of quantas and does not allow properly minimize the radiation doses of an object, as well as unsatisfactory solves the problem of obtaining information on a movable object, since envisages movements of the irradiating beam, which movements reduce the quality of obtained information in case of movable object.

### BRIEF DESCRIPTION OF THE INVENTION

The inventive method for research of internal structure and/or contents of an object solves the aforementioned problems and eliminates the prototype's shortcomings. It comprises the steps of:

a) the object and a source of penetrating radiation move in relation to each other, while the source irradiates the object by a beam of penetrating radiation of an arbitrary form, wherein the beam contains a number of quantas depending upon the time interval, during which the object is being irradiated, and the number is calculated at a predetermined rule that can be changed in different moments of time, or/and for various objects being researched.

b) during the irradiation, and immediately after thereof, a portion of the beam reflected from each irradiated object section, and this portion is registered as a number of quantas, thereby obtaining a numerical-quantum representation of the object's internal structure and contents.

Another problem intended to be solved by the present invention is a method of obtaining an image of an object and/or its internal structure, and/or its contents. This method envisages that, for each point of the object's image, its internal structure, and its contents, a function is computed, which function depends upon a numerical-quantum representation of the internal structure and contents, as well as upon the rule of dependency of the quantas number in the beam and the character of movement of the object and the radiation source in relation to each other.

It is expedient to implement the above-described methods in a system (incorporated in at least one device) comprising: a radiation source, a receiver-gauge of reflected quantas, a memory unit, a unit for obtaining a digital representation of the object's internal structure and/or contents, a unit for obtaining an image of the object's internal structure and/or contents, a unit for display and visualization of the object's internal structure and/or contents.

It is expedient to arrange the radiation source and the receiver-gauge immovable, and the researched object movable in relation thereto.

Optionally, it is expedient to arrange the researched object immovable, and the radiation source and the receptor-gauge movable in relation thereto.

Besides, it is expedient to consider one or several elements of the inventive system, selected from a group consisting of the radiation source, the receptor-gauge of reflected quantas, the memory unit, the unit for obtaining a digital representation, the unit for display and visualization, incorporated in one device.

Also, one or several elements of the inventive system, selected from a group consisting of the radiation source, the receptor-gauge of reflected quantas, the memory unit, the unit for obtaining a digital representation, the unit for display and visualization, designed separately, but the system is incorporated in at least two devices.

The claimed methods and the system for executing thereof provide the following:
it's not necessary to place the radiation source on one side of the object and place the radiation receiver on the other side of thereof that allows for:—imaging objects of essentially greater dimensions than those used in conventional imaging, and—imaging objects jointed to other objects;
it does not make a difference whether the object moves, or the radiation source moves;
it allows for researching certain objects, which cannot be researched by traditional imaging, or those objects that can be damaged or destroyed by traditional imaging;
it allows for reduction of radiation doses to which the object or surrounding objects are exposed;
it significantly raises the quality of information on the internal structure or contents of the object.

### BRIEF DESCRIPTION OF DRAWINGS OF THE INVENTION

FIG. 1 illustrates a flowchart of the proposed system according to a preferred embodiment of the present invention.

FIGS. 2-4 illustrate an increased intenseness of a source's radiation corresponding to the numbers of 0.2*10⁷, 0.4*10⁷, 0.6*10⁷ of gamma-quantas, according to a preferred embodiment of the present invention.

### DESCRIPTION OF PREFERRED EMBODIMENTS OF THE INVENTION

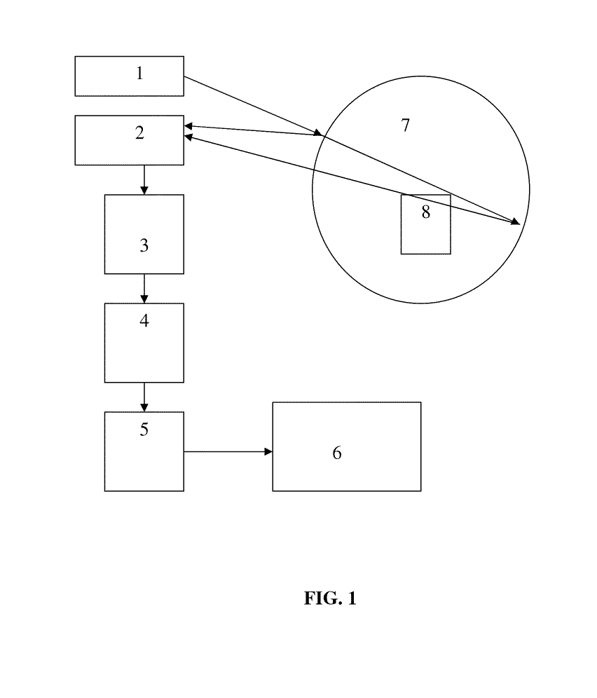

The present invention will be described in detail herein below showing a system of non-destructive control based on reflected radiation, with references to FIG. 1 depicting a flowchart of the system.

The system of non-destructive control in reflected radiation of variable intenseness, schematically illustrated on FIG. 1, comprises: an irradiator unit 1; a receptor-gauge unit 2 that registers quantas reflected by the object being researched; a memory unit 3; a digital representation unit 4 for obtaining a digital representation of internal structure of the object being researched; an image creation unit 5 for obtaining an image of the object being researched and/or the internal structure thereof; and a display unit for display or visualization of the image of object being researched and/or the internal structure thereof. The memory unit 3, the digital representation unit 4, the image creation unit 5 are represented by corresponding modules of a digital computer. FIG. 1 also shows the object being researched 7, and an inner non-uniform structure 8 of the object being researched.

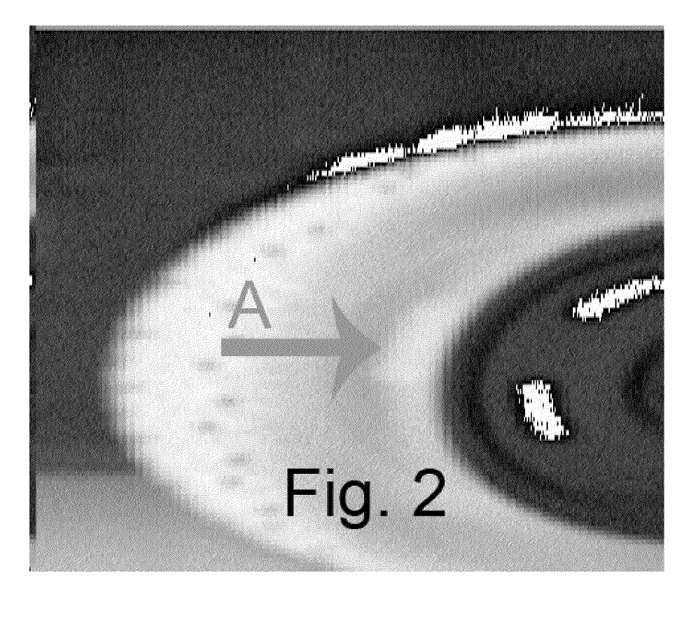

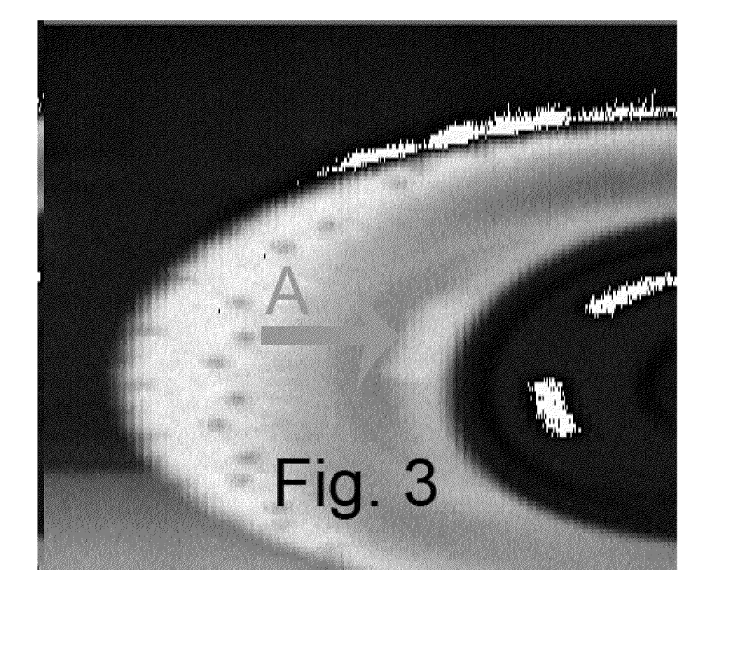

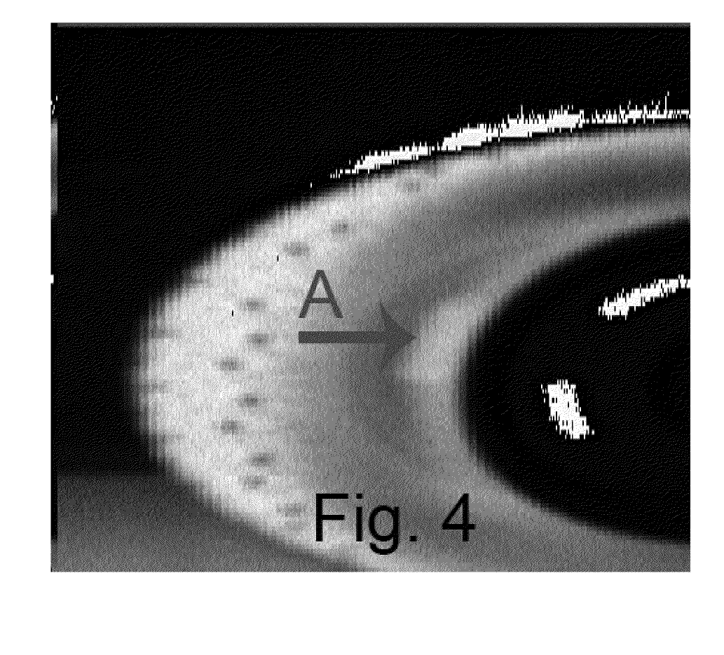

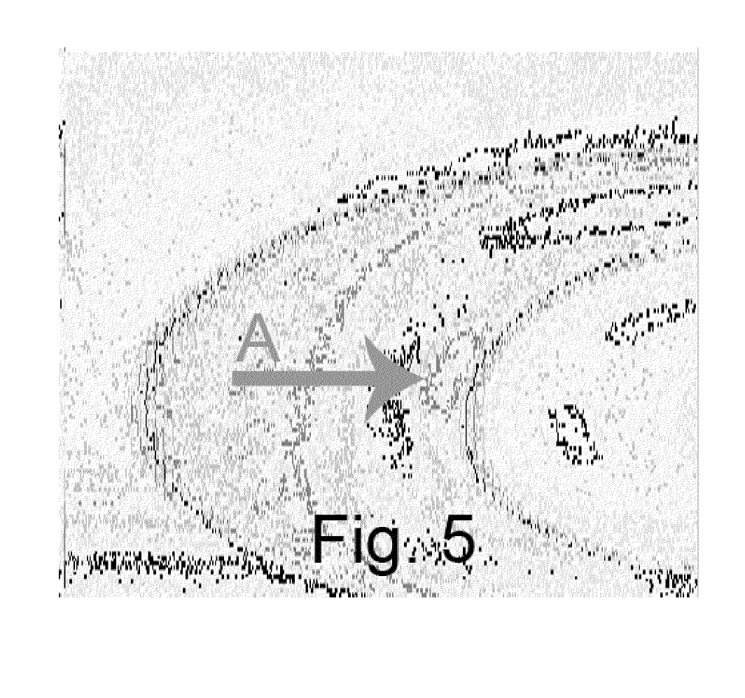

The system operates as follows: the irradiator unit 1 generates an X-ray pulse beam that produces a sufficiently low radiation dose. FIGS. 2-4 illustrate an increased intenseness of radiation corresponding to the numbers of 0.2*10⁷, 0.4*10⁷, 0.6*10⁷ gamma-quantas contained in the beam. The respective images on FIG. 2, FIG. 3, and FIG. 4 show that the image brightness and contrast are increased when the number of gamma-quantas raises. The receptor-gauge unit 2 registers quantas reflected by the frontal surface of the object 7, and reflected by the rear surface of the object 7 coming through the inner non-uniform structure 8, which is depicted on FIG. 1.

The memory unit 3 stores the number of quantas reflected from each point of the object 7 during the movement of the unit 1 or the researched object 7. The digital representation unit 4 provides a digital representation of the internal structure of object 7. The digital representation of the internal structure of object 7 is created using a computer algorithm based on the fact that each point of the object 7 is irradiated by the beam with variable (e.g. incremented) intenseness, and the reflected portion of the beam is registered as a number of quantas, stored in the memory unit 3.

The image creation unit 5 is a computer module that, for each point of the object 7 and its internal structure, calculates a function of dependency upon the registered number of quantas from each irradiated point of the object 7, as well as upon the registered number of quantas from each previous and each next irradiated point of the object 7. The function represents a table of reflected quantas, wherein the numbers of quantas reflected from the current point and from the next point are compared, which allows accounting for frontal and end reflections, which conditions the building an image of the object 7 or/and its internal structure. The unit 6 visualizes the image, and renders thereof on a hard copy or on a display.

FIGS. 2-4 show system operation results for researching a car wheel having a tire and a disc, wherein an object A, represented by a packet with ‘white powder’ (wheat flour was utilized) was hidden in the tire near to the disc. In this case, a traditional through X-ray imaging is not possible, while other known imaging methods are hard to implement, due to the location of object A close to the disc. FIG. 5 depicts an image obtained based on a function of imaging the object and the internal structure thereof, according to the following formula:

R[i]=˜(N[i]̂N[i+1]),

wherein:

the ̂ symbol means bit-summarizing (XOR)

R[i] represents an image of an object's point ‘i’;

N[i] represents a registered number of quantas reflected from the irradiated point ‘i’; N[i+1] represents a registered number of quantas reflected from the next irradiated point ‘i+1’. The function allows obtaining the boundaries of uniformed zones of the object, and thus allows identifying the packet with wheat flour on the left of the disc (shown by arrow A).

As mentioned above, FIGS. 2-4 illustrate an incremented intenseness of radiation represented by the gamma quantas numbers of 0.2*10⁷, 0.4*10⁷, 0.6*10⁷ contained in the radiation beam. Thusly, the beam contains a number of quantas depending upon a time interval, during which the object is irradiated, and which number of quantas is calculated based on a predetermined rule (in this case: an incremental step of 0.2*10⁷), while the number of quantas may generally be changed in different moments of irradiation, and/or for various objects being researched.

The number of gamma quantas in the beam can be conventionally regulated by known means through control of intensity of the radiation source.

It can also be sometimes expedient to smoothly raise the number of gamma quantas in the beam according to a linear function of time, producing a graduate increase of clarity and contrast of the image, which can make the system adaptive to properties of various researched objects.

We claim:

1. A method for research of an object and/or internal structure and/or contents thereof, said method comprising the steps of:
a) moving said object and a source of penetrating radiation in relation to each other,
b) irradiating the object by said source by means of a beam of penetrating radiation, wherein the beam contains a number of quantas depending upon a time interval during which the object is irradiated, wherein the number of quantas is calculated according to a predetermined rule that can be changed for various time moments and various objects; and
c) registering a number of quantas of the beam reflected from each irradiated section of the object simultaneously with irradiation or immediately after irradiation, thereby obtaining a digital quantum representation of the internal structure and/or contents of the object.

2. A method for imaging an object and/or an internal structure and/or contents thereof by a radiation source by means of a beam of penetrating radiation, said method comprising the step of: calculating a function for each point of an image of the object, its internal structure, and contents; wherein said function depends upon a digital representation of the internal structure and/or contents of the object, and said function depends upon a rule of changing the number of quantas in the beam, and a character of movement of the object and the radiation source in relation to each other.

3. A system for executing the method according to claim 1, comprising: said radiation source, a receptor-gauge of quantas reflected from the object, a memory unit, a unit for obtaining the digital representation of the internal structure and/or contents of said object, a unit for obtaining an image of the object and/or internal structure and/or contents thereof, and a unit for display of the image of said object and/or the internal structure and/or contents thereof.

4. A system for executing the method according to claim 2, comprising the radiation source, a receptor-gauge of quantas reflected from the object, a memory unit, a unit for obtaining the digital representation of the internal structure and/or contents of said object, a unit for obtaining an image of said object and/or the internal structure and/or contents thereof, and a unit for display of an image of said object and/or the internal structure and/or contents thereof.

5. The system according to claim 3, wherein the radiation source and the receptor-gauge of reflected quantas are immovable, whereas said object moves relatively to the radiation source and the receptor-gauge.

6. The system according to claim 3, wherein said object is immovable, whereas the radiation source and the receptor-gauge of reflected quantas move relatively to said object.

7. The system according to claim 3, wherein at least one element of the system, selected from the group consisting of: the radiation source, the receptor-gauge, the memory unit, the unit for obtaining the digital representation, the unit for obtaining said image of the object and/or internal structure and/or contents thereof, and the unit for display of said image of the object and/or internal structure and/or contents thereof, is incorporated in at least one device.

8. A method for research of an object and/or internal structure and/or contents thereof by irradiating said object by means of a beam created by a source of penetrating radiation; said method comprising the steps of:
a) moving said object and said source in relation to each other;
b) irradiating the object by means of said beam during a time interval controllably set on said source, said beam containing a number of quantas depending upon the time interval;
c) registering a number of quantas reflected from each irradiated section of the object by means of a receptor-gauge;
d) building an image of said object based on the number of quantas reflected from each irradiated section of the object employing a digital computer; said image is built using a computer algorithm based on the fact that each point of the object is irradiated by the beam with variable intenseness; and
e) obtaining a digital representation of the internal structure and/or contents of the object.

9. The method according to claim 8, further comprising the step of: calculating a function for each point of said image of the object, the internal structure, and contents thereof; wherein said function depends upon the digital representation of the internal structure and/or contents of said object.

10. The method according to claim 9, wherein said function is calculated in accordance with the following formula:
R[i]=˜(N[i]̂N[i+1]),
wherein:
the ̂ symbol means bit-summarizing (XOR)
R[i] represents an image of a point ‘i’ of said object irradiated by said source;
N[i] represents a number of quantas reflected from the point ‘i’ and registered by said receptor-gauge; and
N[i+1] represents a number of quantas reflected from an irradiated point ‘i+1’ being next to the point ‘i’ and registered by said receptor-gauge.

11. The method according to claim 8, further comprising the step of: displaying said digital representation of the internal structure and/or contents of the object.

12. A system for executing the method according to claim 11, comprising:
the radiation source;
the receptor-gauge of quantas reflected from the object;
a memory unit receiving and storing data on a number of quantas reflected from the object;
a unit for obtaining the digital representation of the internal structure and/or contents of said object;
a unit for obtaining the image of said object and/or the internal structure and/or contents thereof; and
a unit for display of the image of said object and/or the internal structure and/or contents thereof;
wherein said memory unit, said unit for obtaining the digital representation, said unit for obtaining the image, and said unit for display of the image are represented by corresponding modules of a digital computer.

13. The system according to claim 12, wherein at least one of the following units: said memory unit, said unit for obtaining the digital representation, said unit for obtaining the image, and said unit for display of the image is incorporated in one device.

14. The method according to claim 9, wherein said function depends upon said predetermined rule and a character of movement of said object and said source in relation to each other.
